(19) United States
(12) Patent Application Publication
(10) Pub. No.: US 2010/0140367 A1
(43) Pub. Date: Jun. 10, 2010

(54) METHOD AND DEVICE FOR FOAMING BALLAST BEDS

(75) Inventors: Wolfgang Pawlik, Koeln (DE); Juergen Wirth, Koeln (DE); Andreas Petersohn, Hennef (DE)

Correspondence Address: LUCAS & MERCANTI, LLP, 475 PARK AVENUE SOUTH, 15TH FLOOR, NEW YORK, NY, 10016, US

(73) Assignee: HENNECKE GMBH, Leverkusen (DE)

(21) Appl. No.: 12/597,253

(22) PCT Filed: Apr. 12, 2008
(86) PCT No.: PCT/EP08/02910

§ 371 Date: Feb. 9, 2010

(30) Foreign Application Priority Data
Apr. 24, 2007 (DE) 10 2007 019 669.7

(51) Int. Cl. E01B 1/00; B05C 5/00

(52) U.S. Cl. 238/2; 118/300

(57) ABSTRACT

The invention relates to a method and device for partially or completely foaming the hollow spaces in the ballast structure of a ballast bed, below which a subgrade (7) is located, having a reactive plastic, wherein the reactive components are mixed in a high-pressure mixer (1,26) and wherein the start time for the reactive mixture (4) is adjusted such that the foaming process substantially only begins when the reactive mixture has reached the subgrade (7).

The invention relates to a method for partially or completely foaming the cavities in the ballast structure of a ballast bed, under which a subgrade is arranged, with a reactive plastic, in which method the reactive components are mixed in a high pressure mixer and in which the starting time for the reactive mixture is set in such a manner that the foaming process essentially begins only when the reactive mixture has reached the subgrade.

The traditional railroad track substantially comprises the ballast bed which is placed on a “subgrade” and in which the railroad ties, which can be composed of wood, concrete or steel and on which the rails are fastened, are embedded.

However, a great problem of said tried and tested technology is the wear of the ballast bed caused by the transporting operation. Wear is understood in this case as meaning the gradual pulverizing of the ballast stones by the enormous dynamic horizontal and vertical track forces. Said pulverizing essentially arises by the ballast stones being able to rotate and to be displaced in relation to one another, and the extreme compression arising in the process causing particles to break off from the ballast stones.

This wear of the ballast bed leads ultimately to distortions of the track and to unevennesses in the railroad track, which have to be eliminated by complicated and costly repair measures. The repairs are undertaken by repacking ballast stones under the track grid and recompressing the repacked ballast stones.

Diverse inventors have been preoccupied with this entire field.

For example, DD 86201 has addressed the problem of substantially increasing the lateral displacement resistance and proposes strengthening the spaces between the railroad ties by curing plastics resins being applied to the section in a metered manner by spraying or casting, the plastic being atomized or cast as a film. That is to say, that patent describes measures for improving the ballast bed stability in relation to horizontal track forces, namely by the ballast stones in the upper region of the ballast structure being adhesively bonded to one another.

However, said patent does not describe measures for improving the stability in relation to vertical track forces.

By contrast, measures for improving the ballast bed stability in relation to horizontal and vertical track forces are proposed in DE-A 20 63 727. In said laid-open specification too, the individual stones of the ballast structure are to be adhesively bonded by a binder in order thereby to prevent the ballast stones from rotating and being displaced.

However, two methods are differentiated in this case:

The stability in relation to horizontal track forces is to be improved by the ballast structure located laterally outside the two rails being adhesively bonded to the contact points “at most” up to approximately the lower edge of the railroad ties.

The stability in relation to vertical track forces is to be improved by the cavities of the ballast structure in the region below the railroad tie bearing being partially or entirely filled up to the subsoil and, as a result, the stones being adhesively bonded in a planar manner.

The ballast stones are to be adhesively bonded at the contact points in the upper region of the ballast structure by “application by rain gun or irrigation”.

The ballast stones are to be adhesively bonded in a planar manner up to the subsoil by “injection” of the binder.

It is possible that the inventors of the applications DE-A 24 48 978, US-A-3 942 448 and EP-A-1 619 305 have been guided by the advice in DE-A 20 63 727 to inject the reactive plastic into the ballast structure. This is because both DE-A 24 48 978 and US-A-3 942 448 describe special embodiments of injection lances.

However, EP 1 619 305 also refers to foam lances in order to inject the reactive plastic into the ballast structure.

Even DE-A 23 05 536, which actually addresses the problem of lifting tracks as a repair measure, describes a special filling probe for injecting reactive plastic under the intersecting point between rail and railroad tie.

However, said filling probes, foam lances or other devices for injecting liquid reactive plastic into the ballast structure of ballast beds that are described in the cited literature all have the same problem:

They tend to become clogged up by the reactive plastic and, after each injection, have to be rinsed with solvent but at least with water, and subsequently blown dry with air, a measure which is no longer acceptable ecologically nowadays. However, the time spent on cleaning the injection devices and the unavoidable loss of raw material are also completely out of the question economically.

It was therefore the object to develop a suitable method and a suitable device for the foaming, which is known per se and is completely expedient, of the cavities in the ballast structure of a ballast bed with reactive plastic, as described in DE-A 20 63 727, in order to prevent the rotation and displacement of the ballast stones in the ballast structure and thereby to substantially increase the service life of the ballast beds, but in which method and device the mixing and discharging system for the reactive mixture can be kept clean in an ecologically satisfactory manner and without losses of raw material.

The invention relates to a method for partially or completely foaming the cavities in the ballast structure of a ballast bed, under which a subgrade is arranged, with a reactive plastic, in which method
a) the reactive components are conveyed in a metered manner to at least one high pressure mixing head where they are mixed, and
b) the liquid reactive mixture output from the high pressure mixing head is applied in a freely flowing manner to the surface of the ballast structure,
   characterized in that
c) the liquid reactive mixture is allowed to flow through the ballast bed as far as the subgrade, and
d) the reactive mixture is subsequently allowed to foam and, as a result, rise by
e) the starting time for the reactive mixture being set in such a manner that the foaming process essentially begins only when the reactive mixture has reached the subgrade.

The reactive plastic is preferably polyurethane.

A subgrade is the separating layer between the permanent way and the road bed of a track structure. The permanent way here generally comprises the track, the railroad ties on which the track is fastened, and the ballast bed in which the railroad ties lie.

Road bed here refers to the entirety of the structures which absorb the forces of the permanent way and conduct them into the earth.

In order to ensure the load-bearing capacity of the road bed in the long term, it is frequently necessary to introduce additional protective layers between the road bed and permanent way.

Said protective layer can serve as a load-bearing layer which better distributes the loads to the subsoil, as a frost protection layer, especially if the subsoil is composed of frost-sensitive ground, and as a filtering and separating layer which prevents the ballast from mixing with the road bed, and as a covering with low water permeability in order to protect water-sensitive ground from surface water.

Further details regarding the subgrade are found in the “Handbuch Gleis [Track Manual]”, 2nd Edition 2004, ISBN 3-87814-804-6, published by Tetzlaff, on pages 193-196.

A ballast bed is understood as meaning a heap of ballast stones. The ballast bed is preferably a ballast bed for track systems, i.e. railroad ties, on which, in turn, rails are fastened, are arranged in the upper region of the ballast bed. In order to obtain a high degree of compactness and bracing of the ballast, the ballast is generally compressed in layers.

Ballasts of differing grain sizes can be used here. For example, the use of ballast with a grain size of 22.4 to 63 mm is customary. Said ballast may also be mixed, if appropriate, with ballast having the grain size of 16 to 22 mm.

More details regarding the ballast grain sizes used in track beds are found in the “Handbuch Gleis [Track Manual]”, 2nd Edition 2004, ISBN 3-87814-804-6, published by Tetzlaff, on pages 173-175.

A ballast structure is understood as meaning that portion of the ballast bed which delimits the cavities.

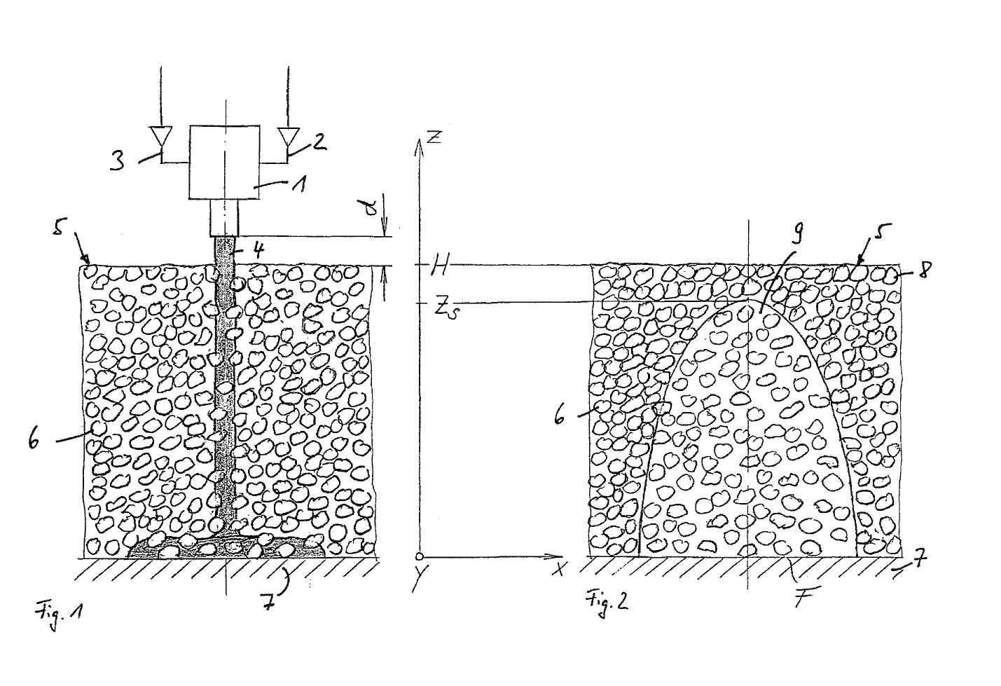

FIGS. 1 to 6 show by way of example the solution to the described objective. They illustrate a method for partially foaming the cavities in the ballast structure of ballast beds with a reactive plastic, for example with polyurethane, wherein railroad ties, on which, in turn, rails are fastened, are arranged in the upper region of the ballast bed.

In this case, the reactive components are conveyed in a metered manner to at least one high pressure mixing head where they are mixed, and the liquid reactive mixture is subsequently applied to the ballast structure above the ballast bed by the high pressure mixing head itself and allowed to flow through the ballast bed as far as the subgrade under the ballast bed. The reactive mixture is then allowed to foam and, as a result, rise. In order to bring about this operation, the “starting time” for the reactive mixture is set in such a manner that the foaming process substantially begins only when the reactive mixture has reached the subgrade.

With the method according to the invention, the criteria, which are described in the objective, for partially foaming the cavities in the ballast structure of ballast beds with a reactive plastic, for example polyurethane, in order to prevent rotation and displacement of the ballast stones in the ballast structure, are fully and entirely satisfied. It is essential in this case that a high pressure mixing head is used for mixing the reactive components.

In a high pressure mixing head, the components are atomized via nozzles, which convert the pressure energy into flow energy, into a small mixing chamber in which they are mixed with one another on account of their high kinetic energy. The pressure of the components upon entry into the nozzles is at an absolute pressure of above 25 bar, and preferably in a range of between 30 to 300 bar. As a rule, the mixing chamber is mechanically cleaned with a ram after the end of a shot. However, there are also mixing heads which are blown out with air. The substantial advantage of the high pressure mixing head is that said mixing heads can be cleaned substantially better and without using solvents after each shot.

Suitable high pressure mixing heads include one-, two- or three-slide mixing heads which are all self-cleaning. That is to say, in said types of mixing head, reactive mixture is mechanically cleaned from the entire mixing and discharging system by means of slides such that no more complicated rinsing and cleaning operations whatsoever are subsequently required.

The decision whether to use a one-, two- or three-slide mixing head depends on the degree of difficulty of the task of mixing the reactive mixture.

In the case of a raw material system which is easy to mix, a one-slide mixing head is entirely sufficient, for example the “groove-controlled mixing head” known everywhere in the polyurethane sector.

For more difficult mixing tasks, a two-slide mixing head, for example the MT mixing head from Hennecke, is required.

For raw material systems which are very difficult to mix, a three-slide mixing head, for example the MX mixing head from Hennecke, should be used. In said high-quality mixing system, there is a control slide for the mixing chamber region, a throttle slide for the throttling zone and a separate slide for the discharging region.

With such a mixing head, not only is excellent mixing possible, but also the mixture output through the separate discharging channel is completely laminar and splash-free.

Therefore, use is preferably made of a high pressure mixing head which has a separate discharging channel and through which the reactive mixture can be output in a laminar and splash-free manner.

Another essential feature of said novel method is the reactive mixture starting time which is adjusted such that it is optimized to the process. This is because it is only possible by this means to apply the reactive mixture to the ballast structure above the ballast bed, to allow said mixture to flow through the ballast bed to the subgrade under the ballast bed and to subsequently allow said mixture to foam and, as a result, to rise.

The starting time is preferably set in the composition via the quantity of activator. A high portion in the composition brings about a short starting time while a low portion brings about a long starting time. The method is particularly flexible if the activator is metered individually, since, as a result, it can react directly and flexibly to the other conditions (ballast bed height, grain size, temperature).

In this case, the amine-containing or organometallic catalysts which are customary in polyurethane chemistry and are generally known can in principle be used as activator. However, low-emission or emission-free catalysts which are not eluted by rain water should preferably be used. Catalysts which react with the rain water to form ecologically acceptable products are particularly preferably used.

By means of said measures, it is possible to allow the polyurethane reactive mixture to flow through the ballast bed and to foam therein in such a manner that the load removing cone below the railroad ties is completely filled with foam, without significant foam portions flowing into the adjacent regions, which, in turn, is a highly essential criterion for the economic efficiency of the method.

With said novel, surprisingly simple method, an ecologically entirely acceptable process is therefore possible, but which also affords economically great advantages, since no raw material losses whatsoever occur here through the mixing and output operation.

The method is surprisingly simple in that it manages, without lances dipping into the heap, to foam defined regions in the heap, which is only bounded downward, by free flowing.

The starting time for the reaction mixture should be 3 to 30 sec, preferably 4 to 20 sec, and particularly preferably 5 to 15 sec. In this case, the starting time which is to be set is dependent on the mixture viscosity of the raw material system, and on the grain size and the compactness of the ballast bed, but in particular on the ballast bed height H which can be from 20 to 40 cm, but also 70 to 80 cm in curves. In addition, the ballast temperature also has an effect on the flow behavior and therefore on the starting time to be set. The suitable starting time can be easily determined empirically by the resultant foaming cone being viewed as a function of the selected starting time.

In order to take this connection into account, it is advantageous, as already mentioned, to separately meter the catalyst or activator determining the starting time and to admix said catalyst or activator to the system. Different variants are possible here—the direct mixing of one of the main reactive components, polyol or isocyanate, into the mixing chamber or the mixing into the supply line.

A further variant is to provide one of the main components with a basic activation or basic catalysis and to add further catalyst or activator only when the need arises.

Somewhat less flexible, but highly cost-effective as a result, is the variant in which the activator is metered in the desired quantity into the top-up quantity stream of one of the main components, preferably the polyol component, and mixed therein.

However, of course, the use of ready-made formulations, in which the catalyst or activator is already admixed to one of the main components, preferably the polyol component, is in principle also conceivable, provided that the formulations are stable on storage.

In a further optimization of the method, it is also possible to vary the size of the contact surface F between the subgrade and the reactive plastic, and the rising height Z_{S} of the reactive plastic foaming within the ballast bed, to be precise essentially by means of the mass M of applied reactive mixture, provided that the chemical and physical parameters, such as, for example, viscosity of the mixture, foaming agent and therefore foam density, are constant. The applied mass M in turn arises from the product of the mass stream \dot{m} per unit of time and the metering time t_{D}.

For an optimum process sequence, it is also highly important for the mixture output at the outlet from the high pressure mixing head to be as laminar as possible in order thereby to ensure that the reactive mixture flows through the ballast bed without disturbance and substantially oriented in the vertical direction; this is because, in the event of a turbulent, splashing mixture output, the reactive mixture would virtually “run” in the ballast structure. In this case, the type of mixing head, as already mentioned, plays an important role, but so too does the speed at which the reactive mixture exits from the mixing head. The speeds permissible for a laminar mixture output are very decisively dependent on the mixture viscosity. Thus, at mixture viscosities of more than 1000 mPas, outlet speeds of up to 10 m/s are entirely possible. However, at mixture viscosities below 500 mPas, only approx. 1 to 3 m/s are permissible.

The outlet speed from the discharge from the high pressure mixing head is preferably set in such a manner that a laminar flow of the reactive mixture at the outlet from the mixing head discharge arises.

An additional influencing variable on the laminar mixture output is also the distance d between the mixing head discharge and ballast structure. At optimum conditions, such as, for example, the use of a three-slide mixing head and mixture outlet speeds of approx. 2 to 5 m/s and mixture viscosities of the order of magnitude of 500 to 1000 mPas, distances of up to 50 cm are entirely possible.

However, the distance should preferably be just 0.5 to 10 cm.

In the further refinement of said novel method, the ballast stones in the ballast bed are temperature-controlled. That is to say, the ballast stones are heated in winter at minus temperatures, and are cooled at extreme heats in high summer.

This is advantageous, since it is thereby possible to maintain virtually constant process conditions, such as, for example, constant viscosity of the reactive mixture and constancy in the reaction kinetics. The optimum operating temperatures of the ballast stones are around approx. 20 to 50° C., preferably around 25 to 40° C., and particularly preferably around approx. 30 to 35° C.

A particularly important use of said novel method is the foam backing of railroad ties which are embedded in the upper region of the ballast bed and on which, in turn, rails are fastened (also see FIGS. 3, 4, 5 and 6).

It is thereby possible to fix the ballast stones in their position in the “load removing cone” below the railroad ties, via which load removing cone the track forces occurring because of the transporting operation are introduced into the subgrade, and therefore said ballast stones can no longer rotate and be displaced, thus considerably increasing the service life of ballast beds.

The railroad ties are foam-backed by the reactive mixture being applied to the ballast structure on both sides, directly next to the railroad ties, to be precise preferably at the same time.

It is advantageous in this case if at least two injection points are arranged in the vicinity of each bearing of the track on the railroad tie, since the load is conducted away from said points via the railroad tie and the ballast bed into the earth. In a preferred embodiment of the method according to the invention, in each case 2 to 8 injection points per bearing of the track section on the railroad tie should not be further than 40 cm away from said bearing of the track section on the railroad tie. Half of said injection points are preferably located on either side of the railroad tie.

In a process which is optimized with regard to the use of raw material, it is even conceivable for the reaction mixture to be injected exclusively in said region. However, it is better if additional injection points are arranged over the entire width of the railroad tie, in order thus overall to minimize the transverse displacement resistance and the settling of the track due to the load. In this case, however, more than 24 injection points per railroad tie are no longer expedient, since in this case the quantity to be inserted per injection point is so small that suitable foam flues can no longer be formed. Consequently, the reactive mixture should be injected at 4 to a maximum of 24 points and preferably at 8 to a maximum of 20 points per railroad tie.

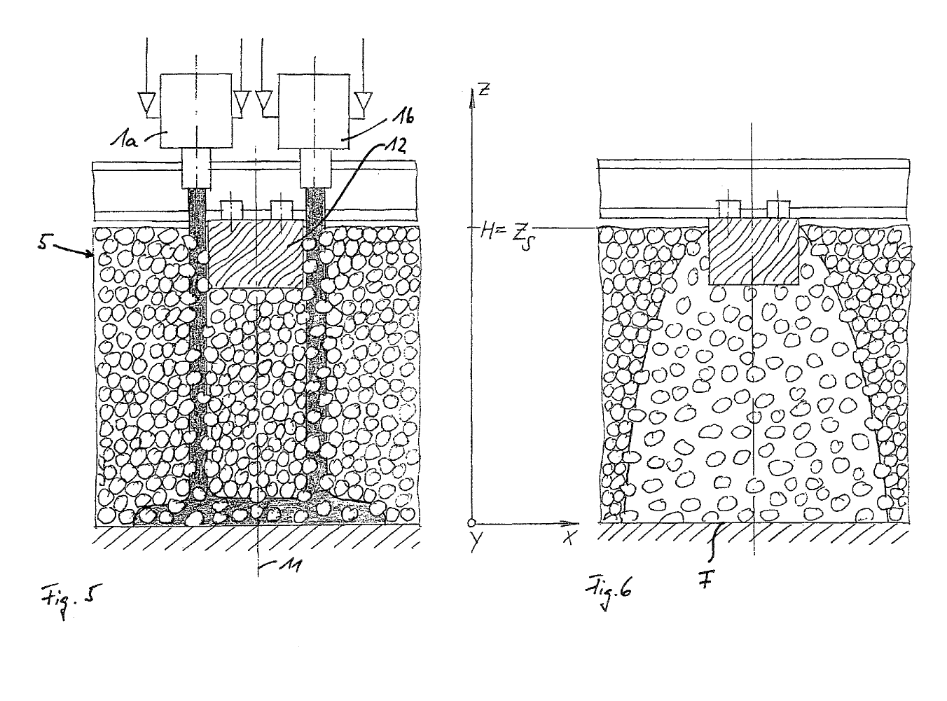

If only one metering unit and only one mixing head are available, there is the option of arranging an “antler-like pipe branch” (see FIGS. 3 and 4) downstream of said one mixing head. This involves a simple distribution of the stream to a plurality of discharging pipes. However, the flow speed should be at least 0.5 m/s so that the antler-like pipe branch does not become clogged too rapidly. However, said “antler-like pipe branch” is not self-cleaning and therefore has to be exchanged from time to time.

The service life for such an antler-like pipe branch is dependent on the reactivity of the reactive mixture. This method is therefore practical only for raw material systems of low reactivity.

In this case, such an “antler-like pipe branch” can be a reasonably priced disposable article made of plastic. In the case of an “antler-like pipe branch” made of metal, there is the possibility of cleansing the latter by fumigation after each use such that it can then be reused.

The solution which is definitely more expensive in terms of investment comprises using two metering units and two mixing heads which output the reactive mixture on both sides of the railroad tie at the same time (see FIGS. 5 and 6). Otherwise, however, said method has the advantage of unlimited applicability. That is to say, said variant can also be used for extremely reactive raw material systems.

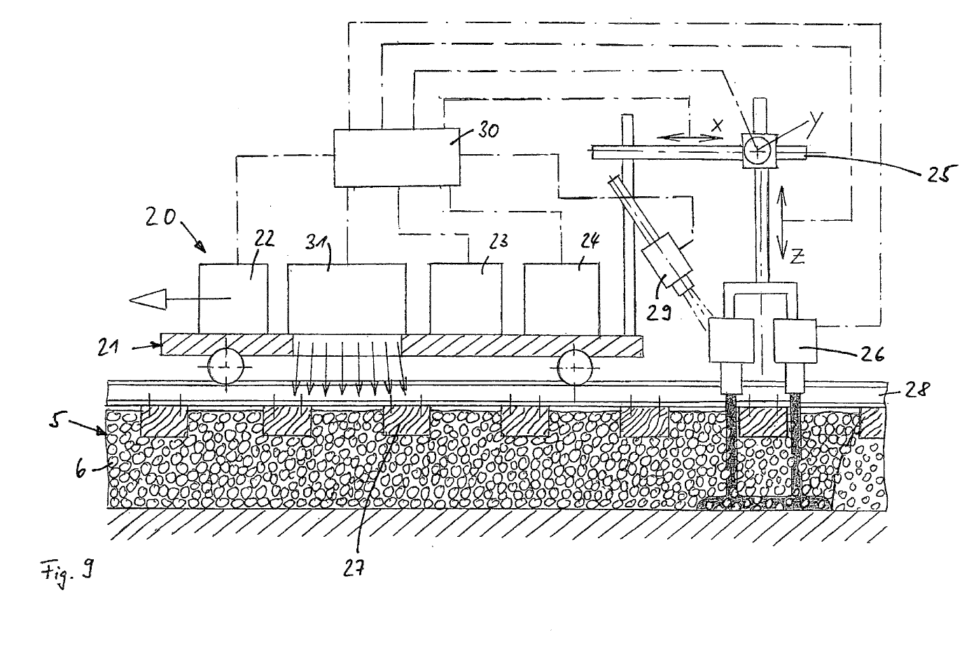

In the further refinement of said method, the mixture is input along the railroad tie, i.e. substantially parallel to the longitudinal axis of the railroad tie (i.e. in the direction of the Y axis in FIG. 8), and preferably substantially in one pass which is interrupted briefly in each case only during the crossing of the rails. That is to say, only the mixture output is interrupted in said phases, but not the continued conveying of the mixing heads.

If only one metering unit and only one mixing head are available, it is also possible for the mixture to be input along the railroad tie, i.e. substantially parallel to the longitudinal axis of the railroad tie (i.e. in the direction of the Y axis in FIG. 8). In this case, the reaction mixture is preferably injected at least 6 points at equal distances per railroad tie side. At each of the at least 6 positions along the Y axis in FIG. 8, the reaction mixture is preferably initially input in each case at a Y position on both sides of the railroad tie before the next position (on the Y axis) along the railroad tie is approached.

This procedure is possible in particular if the time sequence for the two mixture inputs, which are in each case mirror-symmetrical to the longitudinal axis of the railroad tie, to be precise in each case as far as the subgrade, lies within the starting time of the reactive mixture.

Although said method variant is more favorable in terms of the investment costs regarding the outlay on the system than the outlay on the system with two mixing heads, it is significantly less favorable with regard to production costs i.e. substantially with regard to production costs i.e. substantially with regard to the times needed for production.

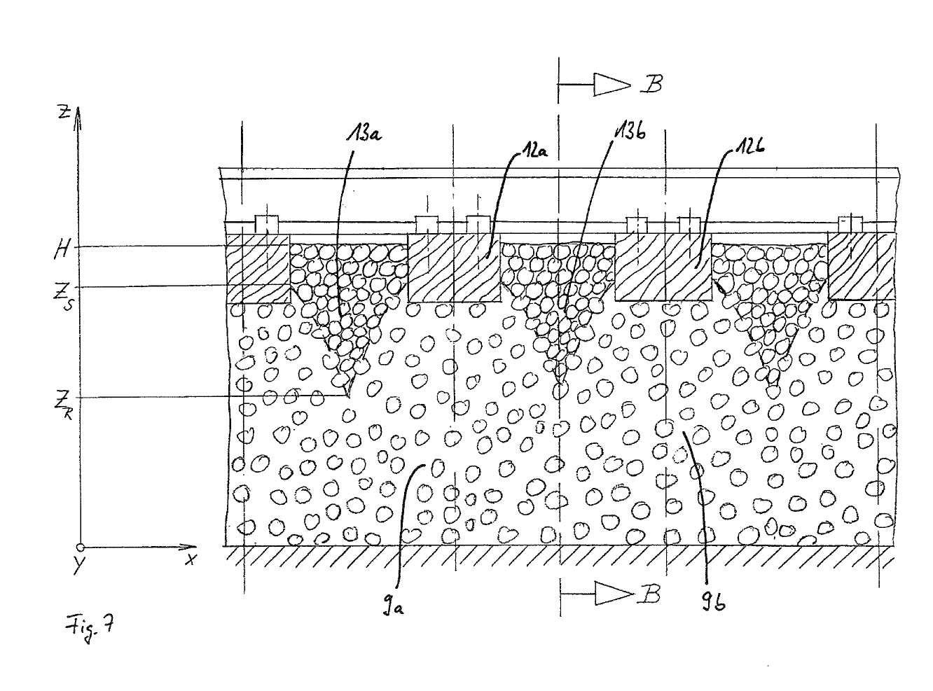

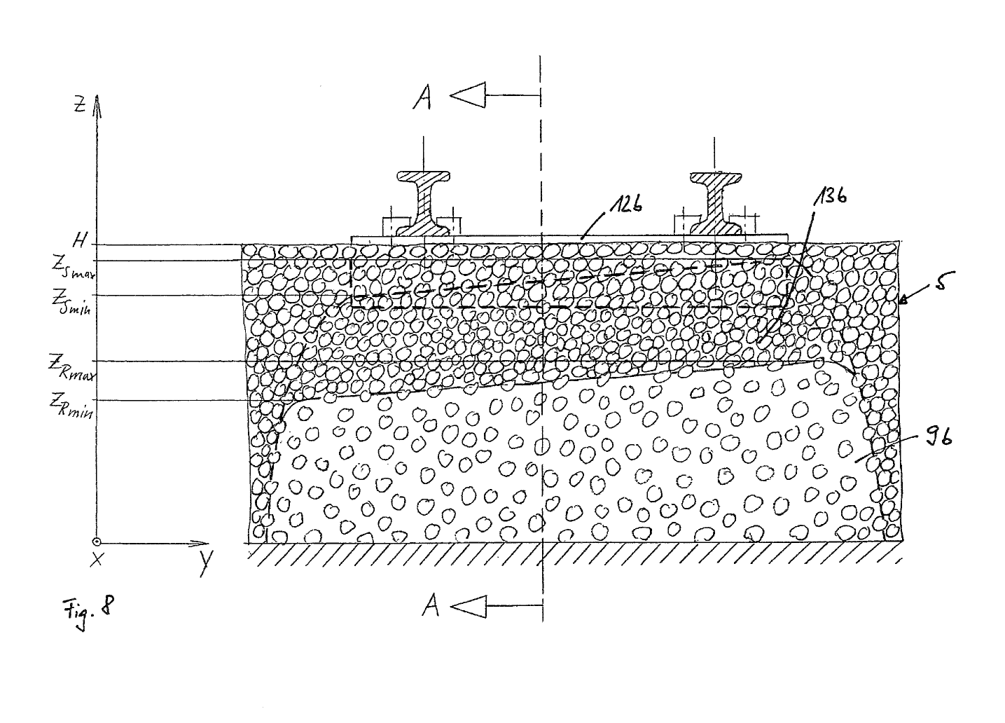

In the further refinement of the method, the mixture input along the railroad tie (kg of reactive mixture/cm of distance) is a function of the distance (i.e. from Y in FIG. 8), and therefore the rising height Z_{S} of the foam rising in the ballast structure is also a function of the distance (i.e. from Y in FIG. 8) (also see in this regard FIGS. 7 and 8).

There are basically two options to bring this about. Firstly, it is conceivable, in particular in the variant with mixture being input at the same time on both sides of the railroad tie given a constant advancing of the mixing head, to change the mixture output per unit of time. However, it is simpler, given a constant mixture output, to change the advancing speed of the mixing head.

However, in the variant with an alternating mixture input along the railroad tie, the adaptation of the metering time from step to step is the more expedient method.

Said method variant (rising height Z_{S}=f(Y), i.e. function of the distance parallel to the longitudinal axis of the railroad tie) makes it possible, as illustrated in FIGS. 7 and 8, for Z_{S} to rise continuously from one to the other side of the ballast bed, the rise being approx. 2° to 10°, preferably 3° to 8°, and particularly preferably 4° to 6°. This causes Z_{R} also to rise accordingly from one to the other side of the ballast bed (see again FIGS. 7 and 8). This is because Z_{R}=f(Y) is the intersecting line formed between two foam mountains in adjacent railroad ties. By inclining said conduits formed between the foam mountains, it is therefore possible to dewater the free ballast zones located above the foam mountains such that no damaging waterlogging whatsoever can arise about the entire ballast bed.

One variant for dewatering the ballast bed involves designing the center line of the ballast bed, as seen in the direction of travel, as it were as a water shed, i.e. the maximum rising height Z_{Smax} is in the center of the railroad tie and the drainage conduits extend from the center of the ballast bed to the sides of the ballast bed.

This permits a slope of double height. Such a raised slope not only improves the dewatering, it also provides a greater range of tolerances with regard to local fluctuations in the angle of inclination which may entirely possibly arise due to rising height tolerances of the plastic flues.

In an advantageous refinement of the method, the ballast bed ends at the point at which the foam is input at the lower end of the railroad ties and, if appropriate, can be subsequently filled up further. In this case, the reaction mixture can be input directly next to the railroad tie. It is possible, as a result, in an even more targeted manner to foam only the load removing cone, thus enabling the consumption of raw material to be somewhat reduced, which, of course, has a positive effect on the economic efficiency of the method.

The invention also relates to a device for foaming the cavities in the ballast structure of a ballast bed, under which a subgrade is arranged, with a reactive plastic, the device comprising
a) a rail vehicle, and
at least one metering unit which is arranged on the rail vehicle, intended for metering a polyol-containing reactive component and is connected hydraulically via lines to the associated containers for the polyol component, and
c) at least one metering unit which is arranged on the rail vehicle, is intended for metering an isocyanate component and is connected via lines to the associated containers for the isocyanate component, and
d) at least one high pressure mixing head which is connected hydraulically via lines to the metering units for the polyol-containing reactive component and for the isocyanate component, and
e) at least one metering unit for an activator or catalyst, which metering unit is connected hydraulically via lines to the metering unit or the associated container for one of the reactive components, or directly to the high pressure mixing head.

A self-cleaning high pressure mixing head, whether in the form of a one-, two- or three-slide mixing head, is always preferred as the mixing head. Although there are also air-cleaned high pressure mixing heads, the use thereof would considerably reduce the advantages of the method described, in particular in an ecological respect.

In order to supply the high pressure mixing head with the reactive components, the metering units for the two reaction components—polyol and isocyanate—have to be suitable for applying absolute pressures of at least 25 bar, preferably of 30 to 300 bar.

The metering unit for the activator is important in order to be able to react in a flexible manner to the other conditions (ballast bed height, grain size, temperature). The most flexible solution involves metering the activator individually into the mixing head. One alternative constitutes impregnating the polyol stream with the activator which is then injected into the mixing chamber via the polyol nozzle. However, in this case, the activator must only be injected at the time of the shot, since it is otherwise enriched in an undefined manner in the polyol container. The impregnating of the isocyanate stream with the activator is also conceivable.

A more favorable and generally similarly practical solution is the metering of the activator into a metered top-up stream of one of the reaction components. A batch approach with the suitable activation is thereby available. Of course, this variant is somewhat less flexible, since the activation cannot be changed from shot to shot. However, since the other conditions, such as temperature, ballast bed height or grain size, generally cannot change suddenly either, this may nevertheless constitute a practical solution.

The metering unit for the activator is generally a suitable metering pump. However, different types of metering are also conceivable. For example, the activator could also be metered into one of the reaction components by means of preliminary pressure and a valve which can be activated flexibly and switched rapidly.

In order to be able to use the device in any season, units for controlling the temperature of the ballast bed also have to be arranged on the rail vehicle. In order, namely for the foaming process, to have the optimum temperatures of approx. 15° C. to 35° C., it is necessary to correspondingly heat the ballast bed in the cold season and to cool it on hot summer days.

For the foaming process, it is also just as important to dry the ballast bed, since water reacts with isocyanate, and therefore, if the ballast bed were moist, the foaming process would proceed in a completely uncontrolled manner.

In a preferred embodiment of the method, the ballast bed is therefore produced first of all from washed, dried and compressed ballast. The dry ballast bed is either then immediately thereafter directly foamed in accordance with the characterizing part according to the invention from claim 1, or said ballast bed is temporarily covered in a suitable manner to protect from rainwater so as to keep said ballast bed dry until the foaming time. For this purpose, it is possible, for example, to place a tarpaulin over the dry ballast bed. However, the use of simple mobile wagons which, in the simplest case, merely comprise a structure with a covering and wheels, is also conceivable. The advantage of this variant is that, of course, the ballast can be dried substantially more easily when it is not yet located in the track bed. Otherwise, it is possible only with a very high outlay of energy to dry the ballast as far as the subgrade. It would be ideal if the foaming machine is arranged directly behind the machine which produces the ballast bed, and therefore the dry ballast bed is always directly foamed.

It is also advantageous if handling appliances for guiding the at least one mixing head are available on the rail vehicle, since self-cleaning mixing heads may be relatively heavy. The weight of a mixing head of this type may be 10 kg, but it is entirely possible also for it to be 50 kg.

In the further refinement of said device, the handling appliances are also assigned a sensor arrangement in order to position the mixing head. It is thereby possible to allow the foaming process to proceed completely automatically.

The discharge from the high pressure mixing head is preferably oriented substantially in the vertical direction (i.e. with a maximum angle of inclination in relation to the vertical of 10°) such that the reactive mixture can be output in the vertical direction in a free flowing and as laminar as possible a manner (i.e. avoiding splashes). Expressed in other words, the discharge from the high pressure mixing head is oriented substantially perpendicularly to the direction of travel of the rail vehicle (i.e. with a maximum angle of inclination in relation to the perpendicular to the direction of travel of 10°).

In a further refinement of the device, the rail vehicle has wheels, the discharge from the high pressure mixing head being located in the output direction from the high pressure mixing head at a maximum of 30 cm upstream of the rearmost extent of the wheels in the output direction and particularly preferably even projecting over the rearmost extent of the wheels in the output direction. The discharge from the high pressure mixing head very particularly preferably protrudes over the rearmost extent of the wheels in the output direction by up to 15 cm, in particular preferably by up to 10 cm. The effect achieved by this is that the preferably laminar output of mixture from the high pressure mixing head strikes in a precisely targeted manner on the ballast structure in order to thereby ensure that the reactive mixture flows through the ballast bed in an undisturbed manner and oriented substantially in the vertical direction. This is because, given a turbulent, splashing output of mixture, the reactive mixture would be distributed widely over the surface of the ballast structure, and the reactive mixture would virtually “run” in the ballast structure.

The invention is explained in more detail with reference to the following diagrams, in which:

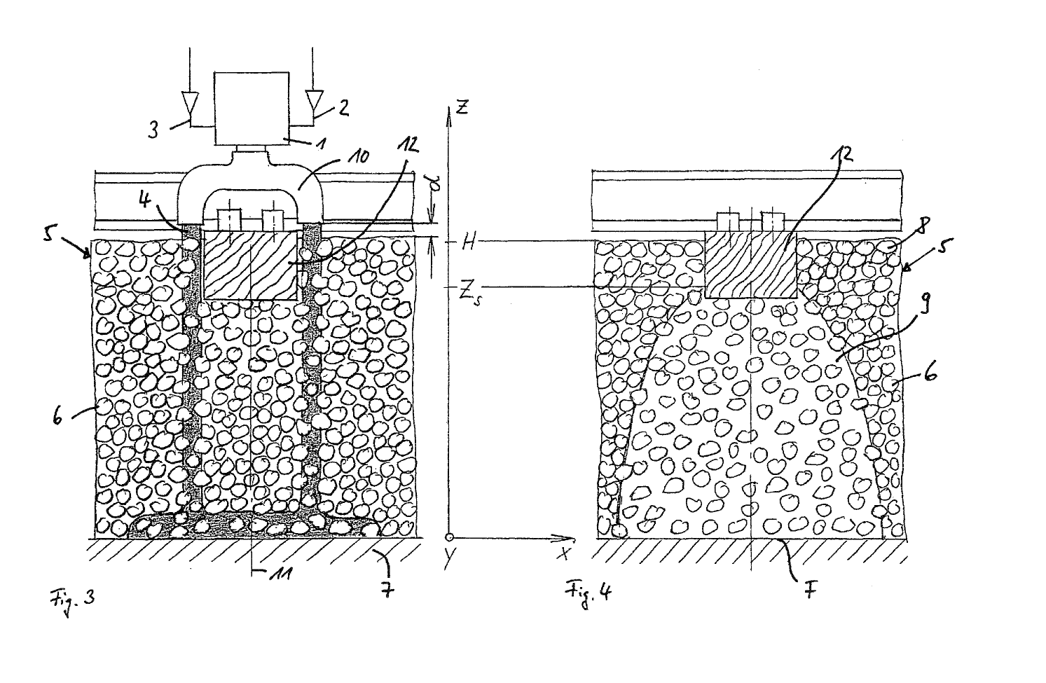

FIG. 1 and FIG. 2 show diagrammatically the basic sequence of the method according to the invention,

FIG. 3 and FIG. 4 show diagrammatically the foam backing of a railroad tie using a high pressure mixing head having an antler-like pipe branch connected downstream,

FIG. 5 and FIG. 6 show diagrammatically the foam backing of a railroad tie using a tandem mixing head system,

FIG. 7 shows diagrammatically a track portion having a plurality of foam-backed railroad ties in the section A-A (corresponding to FIG. 8),

FIG. 8 shows diagrammatically a ballast bed in the section B-B (corresponding to FIG. 7), and

FIG. 9 shows diagrammatically a device according to the invention for partially foaming the cavities in the ballast structure of a ballast bed with reactive plastic, for example with polyurethane.

In FIG. 1, polyurethane reactive components are conveyed from storage containers via metering units (not illustrated in the diagram) by means of connecting lines 2, 3 to a self-cleaning high pressure mixing head 1 where they are mixed. The liquid reactive mixture 4 is subsequently applied above the ballast bed 5 to the ballast structure 6 (i.e. to the ballast portion of the ballast bed) and allowed to flow through the ballast structure as far as the subgrade 7.

The mixture output at a mixture viscosity of approx. 600 mPa sec and an output speed of approx. 3 m/s and at a distance d of approx. 50 mm between the ballast structure and mixing head discharge is completely laminar and splash-free.

In the example shown in FIG. 2, the ballast bed has a height H of approx. 30 cm. The metering time is approx 2 sec. After approx. 4 seconds, the liquid reactive mixture has reached the subgrade and is distributed on the subgrade 7 over an area F of approx. 350 cm². After approx. 2 more sccs, the chemical reaction of the polyurethane reactive mixture begins (also see FIG. 4). That is to say, the starting time for the polyurethane reactive mixture is likewise approx. 6 sec. The chemical reaction causes the production of a foaming agent which causes the reactive mixture to foam and rise through the ballast structure 6 in the ballast bed 5.

The rising height Zs of the foamed reactive plastic is approx. 25 cm. Approx. 30 sec after the beginning of the reaction, the foaming process is ended and the reactive plastic cures, as a result of which a flue 9 of reactive plastic is formed in the ballast structure of the ballast bed, in the region of which flue the ballast stones 8 are fixed in their position and therefore can neither rotate nor be displaced.

FIG. 3 shows diagrammatically a specific use of the method according to the invention, namely the backing of a railroad tie with foam. In this case, polyurethane reactive components are conveyed from storage containers via a metering unit (not illustrated in the diagram) by means of connecting lines 2, 3 to a self-cleaning high pressure mixing head 1 where they are mixed. An “antler-like pipe branch” 10 is arranged downstream of the high pressure mixing head 1 and is used to apply the liquid reactive mixture 4 to the ballast structure 6 symmetrically with respect to the vertical transverse axis 11 of the railroad tie 12 which is arranged in the upper region of the ballast bed 5. The mixture is input on both sides directly next to the railroad tic 12, to be precise at the same time in this case. In this example, the lateral distance between the railroad tie and the inflow of mixture into the ballast structure is approx. 20 mm on each side of the railroad tie.

Also in this application, the liquid reactive mixture 4 is applied to the ballast structure 6 above the ballast bed 5 and allowed to flow through the ballast structure as far as the subgrade 7.

At a mixture viscosity of approx. 600 mPas and an output speed of approx. 3 m/s, the mixture input is completely laminar and splash-free at a distance d of approx. 50 mm between the ballast structure 6 and the mixture discharge from the antler-like pipe branch 10.

In this example, the ballast bed also has a height H of approx. 30 cm.

The metering time is approx. 2 sec. After approx. 4 seconds, the liquid reactive mixture 4 has reached the subgrade 7 and is distributed on the subgrade over the area F of approx. 350 cm² shown in FIG. 4. After a further approx. 2 sec, the chemical reaction of the polyurethane reactive mixture begins (also see FIG. 4). That is to say, the starting time for the polyurethane reactive mixture is likewise approx. 6 sec.

The chemical reaction produces a foaming agent which causes the reactive mixture to foam and rise through the ballast structure 6 in the ballast bed 5. The rising height Z_{S} of the foamed reactive plastic is approx. 25 cm.

After a total of approx. 30 sec after the beginning of the reaction, the foaming process is ended and the reactive plastic cures, as a result of which a flue 9 of reactive plastic is produced in the ballast structure of the ballast bed (also see FIG. 4), said flue reaching into the lower region of the railroad tie 12 and fixing the ballast stones 8 in their position in the “load removing cone” below the railroad tie 12 and thus securing said ballast stones against rotation and displacement.

This reduces the edge pressures between the ballast stones, caused by the forces introduced into the ballast bed by the transporting operation and, as a result, in turn prevents the ballast stones from being pulverized, and therefore the service life of ballast beds is substantially increased.

FIGS. 5 and 6 show a variant of the foam backing of railroad ties 12 arranged in the upper region of ballast beds 5. Polyurethane reactive components are likewise conveyed here from storage containers, but in this case via two metering units (not illustrated in the diagram), to two high pressure mixing heads 1a, 1b where they are mixed.

The mixture is in turn discharged from the two high pressure mixing heads 1a, 1b symmetrically with respect to the vertical transverse axis 11 of the railroad tie 12, to be precise preferably at the same time. The lateral distance between the railroad tie and the respective inflow of mixture into the ballast structure is approx. 20 mm. Greater lateral distances of up to approx. 50 mm permit a substantially greater tolerance for the mixing head guiding system (also see FIG. 9) and are entirely permissible. The method sequence is the same as already described in FIGS. 1 and 2, and 3 and 4. The ballast bed height H is also again 30 cm.

However, in this example, the metering time is somewhat longer. It is approx. 2.5 sec. As a result, the time for the liquid reactive mixture to run through the ballast structure changes to approx. 5 sec, but still lies within the starting time of 6 sec. The subgrade area F wetted by liquid reactive plastic is accordingly likewise larger, as illustrated in FIG. 6. It is now approx. 440 cm². The rising height Z_{S} is also greater. It now corresponds approximately to the ballast bed height of 30 cm.

FIG. 7 shows diagrammatically a track portion with a plurality of foam-backed railroad ties 12a, 12b. It is particularly clear here how the ballast stones are fixed in their position within the load removing regions below the railroad ties 12a, 12b by the polyurethane plastic. However, FIG. 7 also shows that conduits 13a, 13b are formed between the individual plastic flues 9a, 9b below the railroad ties.

FIG. 8, which corresponds to FIG. 7, illustrates a solution in which the water outflow is assisted by the conduits 13a, 13b.

(FIG. 7 is the section A-A in FIG. 8, and FIG. 8 is the section B-B in FIG. 7).

In this example, the conduit 13b between the plastic flues 9a, 9b below the railroad ties 12a, 12b is inclined transversely with respect to the ballast bed 5. This makes it impossible for any possibly damaging waterlogging to form in the free ballast regions above the plastic flues 9a, 9b.

In the example illustrated, the angle of inclination is approx. 5°. In this example, the maximum possible angle of inclination is substantially determined by the railroad tie length and railroad tie thickness, since the maximum possible difference in rising height (Z_{Smax}−Z_{Smin}) then approximately corresponds to the railroad tie thickness. This is because Z_{Smin} always has still to be of a sufficient height that a satisfactorily foamed load removing cone is still located at this point below the railroad tie and Z_{Smax} in turn should not substantially exceed the ballast bed height.

Since (Z_{Smax}−Z_{Smin}) is approximately proportional to (Z_{Rmax}−Z_{Rmin}), a corresponding angle of inclination is also produced for the dewatering conduits.

FIG. 9 shows diagrammatically a device 20 according to the invention for partially foaming the cavities in the ballast structure 6 of a ballast bed 5 with reactive plastic, for example with polyurethane.

Containers 23 and a double metering unit 24 for the reactive components are arranged on a rail vehicle 21 having a drive 22. Furthermore, a three-coordinate mixing head guiding system 25 for a tandem mixing head system having two mixing heads 26 is located on the rail vehicle 21. The connecting lines between containers, double metering unit and the mixing heads are not illustrated in this diagram.

The Y coordinate guide is necessary in order to guide the mixing heads 26 along the railroad ties 27.

The Z coordinate guide is required in order firstly to lift the mixing heads 26 over the rails 28, but in particular in order to position said mixing heads to the required distance from the ballast structure 6.

Since the rail section runs not only rectilinearly, but also includes curves, an X coordinate guide is also necessary.

In order to enable automatic operation, the mixing head guiding system is also assigned a sensor arrangement 29 which transmits the railroad tie and rail positions to a master control device 30 and controls the X, Y, Z movements of the mixing head guiding system 25.

In order to bring this about, pulse lines (illustrated by interrupted lines) lead from the sensor arrangement 29 to the control device 30 and from the latter to the mixing head guiding system 25.

When the foaming of a railroad tie region is finished, the control device 30 emits a pulse to the drive 22 for the rail vehicle 21 such that the next railroad tie position is approached.

A temperature control device 31 is also arranged on the rail vehicle 21. The temperature of the ballast stones is transmitted via a temperature sensor—not illustrated in the diagram—to the control device 30 which, in turn, switches on the temperature control device 31 when the need arises. The optimum temperature for the foaming process is around approx. 30° C. That is to say, the ballast stones have to be heated in winter and cooled during high summer heat.

The conditions (pressure, temperature, filling level) for the containers 23 and for the double metering unit 25 are also monitored by means of indicators (not illustrated in the diagram) and transmitted to the control device 30 which, in the event of tolerances being exceeded, either emits a signal or initiates a relevant measure (not illustrated however in the diagram).

FIG. 9 likewise shows the preferred embodiment in which the discharge from the high pressure mixing head 26 in the output direction from the high pressure mixing head (i.e. substantially in the vertical direction) protrudes over the rearmost extent in the output direction of the wheels (i.e. the contact point of wheels and rail 28). The effect achieved by this is that the preferably laminar mixture output from the high pressure mixing head strikes in a precisely targeted manner against the ballast structure in order thereby to ensure that the reactive mixture flows through the ballast bed in a manner substantially oriented in the vertical direction and without disturbance.

1. A method for partially or completely foaming the cavities in the ballast structure of a ballast bed, under which a subgrade is arranged, with a reactive plastic, in which method
a) the reactive components are conveyed in a metered manner to at least one high pressure mixing head where they are mixed, and
b) the liquid reactive mixture output from the high pressure mixing head is supplied in a freely flowing manner to the surface of the ballast structure,
characterized in that
c) the liquid reactive mixture is allowed to flow through the ballast bed as far as the subgrade, and
d) the reactive mixture is subsequently allowed to foam and, as a result, rise by
e) the starting time for the reactive mixture being set in such a manner that the foaming process essentially begins only when the reactive mixture has reached the subgrade.

2. The method as claimed in claim 1, characterized in that the starting time for the reactive mixture is 3 to 30 sec.

3. The method as claimed in claim 1, characterized in that the starting time is determined by a catalyst or activator which is metered separately into the high pressure mixing head and mixed in.

4. The method as claimed in claim 1, characterized in that the starting time is determined by a catalyst or activator which is injected separately into the metering stream of one of the main components.

5. The method as claimed in claim 1, characterized in that the starting time is determined by a catalyst or activator which is metered separately into the top-up quantity stream of one of the reactive components and mixed in, said reactive mixture then being supplied to a working container.

6. (canceled)

7. The method as claimed in claim 1, characterized in that the reactive mixture exits from the at least one high pressure mixing head at a speed of 0.5 to 10 m/s.

8. The method as claimed in claim 1, characterized in that the distance d between the at least one high pressure mixing head and the ballast structure is at maximum 50 cm.

9. The method as claimed in claim 1, characterized in that the ballast stones in the ballast bed are temperature controlled.

10-14. (canceled)

15. A device for foaming the cavities in the ballast structure of a ballast bed, under which a subgrade is arranged, with a reactive plastic, the device comprising
a) a rail vehicle, and
b) at least one metering unit which is arranged on the rail vehicle, intended for metering a polyol-containing reactive component and is connected hydraulically via lines to the associated containers for the polyol component, and
c) at least one metering unit which is arranged on the rail vehicle, is intended for metering an isocyanate component and is connected via lines to the associated containers for the isocyanate component, and
d) at least one high pressure mixing head which is connected hydraulically via lines to the metering units for the polyol-containing reactive component and for the isocyanate component, and
e) at least one metering unit for an activator or catalyst, which metering unit is connected hydraulically via lines to the metering unit or the associated container for one of the reactive components, or directly to the high pressure mixing head.

16. The device as claimed in claim 15, characterized in that a working container containing a mixture of polyol and the activator or catalyst is present on the rail vehicle, and in that said container is connected hydraulically via lines to a further metering unit for a polyol component and to storage containers for the polyol component, and to the metering unit and a storage container for the activator, a mixing device for mixing the activator or catalyst into the polyol stream being present between the metering units and the working container.

17. The device as claimed in claim 16, characterized in that units for controlling the temperature of the ballast bed are also arranged on the rail vehicle.

18. The device as claimed in claim 15, characterized in that units for drying the ballast bed are also arranged on the rail vehicle.

19. The device as claimed in claim 15, characterized in that handling appliances for guiding the at least one high pressure mixing head are also arranged on the rail vehicle.

20. The device as claimed in claim 19, characterized in that the handling appliances are also assigned a sensor arrangement for detecting the positions of railroad ties or rails arranged on the ballast bed.

21. The device as claimed in claim 15, characterized in that the rail vehicle has wheels, the discharge from the high pressure mixing head being located in the output direction from the high pressure mixing head at a maximum of 30 cm upstream of the rearmost extent of the wheels in the output direction and preferably even projecting over the rearmost extent of the wheels in the output direction.

22. The device as claimed in claim 15, characterized in that the discharge from the high pressure mixing head is oriented substantially perpendicularly to the direction of travel of the rail vehicle.
